(19) United States
(12) Patent Application Publication
(10) Pub. No.: US 2017/0252779 A1
(43) Pub. Date: Sep. 7, 2017

(54) Tool for separating ash from coals

(71) Applicant: Joel Price, Fairfield, IA (US)

(72) Inventor: Joel Price, Fairfield, IA (US)

(21) Appl. No.: 15/058,962

(22) Filed: Mar. 2, 2016

(51) Int. Cl. B07B 1/02; F24B 15/00; F24B 13/00

(52) U.S. Cl. CPC B07B 1/02; F24B 13/006; F24B 15/007

(57) ABSTRACT

The present invention was founded on the basic object of providing an apparatus for safely and efficiently sifting dust and ash and other relative small particles from larger particles, such as incompletely burned coals. A further object of the invention is to provide a sieve that enables a sifting of particulate matter from incompletely burned coals while inside a combustion chamber of a fireplace, stove, or the like. In an exemplary embodiment the invention includes a sieve with sides and bottom having a plurality of apertures dimensioned so that the sieve sides and bottom fit entirely within the confines of the object to be cleaned, and a handle fixed to the sieve such that the handle does not extend far, such as 1/2″ or less, above the top of the sieve.

### FIELD

The present invention relates generally to ash sieves. More particularly, disclosed herein is a sieve for enabling the separation of dust, ash and the like from coals to permit, for example, the removal of the dust and ash from a fireplace, firebox, wood stove, barbeque grill, or the like while enabling the retention of the coals for the full and efficient consumption thereof and for the retained hot coals use in rapidly rekindling fires.

### BACKGROUND

Wood, coal, and other solid fuels have been used to heat residences and commercial establishments for centuries. It would be appreciated that it is economically advantageous to get the most energy from wood, coal, charcoal briquettes, heating pellets, and other forms of burnable fuel. It would be ideal, therefore, to ensure that as little unburned fuel as possible is removed from the fireplace or stove during cleaning and the like. One knowledgeable in the art will also be aware that removing as little unburned fuel as possible is desirable to minimize the volume of waste with which a party must contend.

The usual pattern of home heating allows a fire to burn down to the level of ashes and coals either overnight, or during the day, at which time it is desirable to restart the fire promptly. One way to do this is to simply place logs on the residual bed of mixed coals and ashes. However most fireboxes perform less efficiently as ashes accumulate in the bottom, and eventually, the ash/coal mixture must be removed. The mixture must either be removed hot, which presents a disposal problem since the heat wafts considerable ash into the room and the mixture serves as an ignition source when discarded, or the fire must be allowed to die down further, which requires a period of time during which no heat is being provided.

Then in order to start a new fire, one must use paper or a similar low heat fuel, followed by kindling, and finally by the main fuel, which is usually logs, pellets or coal. Ten to twenty minutes of effort and close attention, plus a large amount of prepared paper and kindling, with a corresponding large amount of poor combustion is needed to use this method. The present invention allows a way to separate the still usable coals from the ashes, so that the ashes can be discarded. The coals can then be used to promptly restart a new fire without the need for paper, kindling or extensive time and attention.

A number of prior art inventors, such as Brooks in U.S. Pat. No. 71,969, Cipriano in U.S. Pat. No. 1,675,092, Fisher in U.S. Pat. No. 2,005,416, Neugent in U.S. Pat. No, 4,305,376 to Neugent, Klangos in U.S. Pat. No. 7,712,805, and Dixon in U.S. Pat. No. 6,658,285, have sought to provide hand tools for enabling the easy, efficient, and safe sifting of materials. To date, however, the proposed solutions of the prior art have been comparatively limited in effectiveness and complex in structure and operation.

For example, many devices of the prior art have disadvantageously removed significant amounts of large coals, embers, and other uncombusted materials from the combustion area thereby leading to unnecessary energy losses. The effectiveness of other prior art constructions has been inhibited by components that inadequately secure hot coals during the removal and transfer of ash from the combustion area to a waste container thereby representing not only a significant fire hazard but also a messy and inefficient arrangement. Still further, certain prior art devices employ moving parts whose function is impaired by individual and repeated heating effects, including thermal expansion and contraction, thereby leading to malfunctioning and premature failure. Still further, certain prior art devices would require significant amounts of time to thoroughly separate ash from coals, disadvantageous on its own, but also leading to excessive cooling of the coals. Still further, scoop or shovel designs which seek to accomplish the separation of ash and coals suffer from the inability to efficiently achieve the antagonistic goals of facilitating scooping material into the shovel-type device while also attempting to facilitate retaining desired material in the shovel-type device.

In light of the foregoing, it will be appreciated that there is a need in the art for a sifting tool for enabling the safe and efficient sifting of coals from dust, ash, and the like to permit, for example, the removal of the dust and ash from a furnace, stove, or the like while enabling the efficient retention of coals in the combustion area for permitting the full and efficient consumption thereof with minimal waste.

### SUMMARY

This section provides a general summary of the disclosure, and is not a comprehensive disclosure of its full scope or all of its features.

With an appreciation for the state of the art summarized above, the present invention was founded on the basic object of providing an apparatus for safely and efficiently sifting dust and ash and other relative small particles from larger particles, such as incompletely burned coals.

A further object of the invention is to provide a sieve that enables a sifting of particulate matter from incompletely burned coals while inside a combustion chamber of a fireplace, stove, or the like.

A more particular object of embodiments of the invention is to provide a sieve of static construction and operation to enable particulate matter to be sifted without impedance that might otherwise derive from thermal deformations of components of the apparatus.

A further object of embodiments of the invention is to enable uncombusted coal, wood, fuel pellets, and other solid fuel remnants to remain within a combustion chamber for full combustion thereof.

A related object of embodiments of the invention is to provide a sifting shovel that minimizes the waste that is yielded during cleaning of a combustion chamber.

An additional object of the present invention is to provide a sieve that can be manufactured in a simple and facile manner,

Some Advantages of the Invention:

1. The tool of the present invention is a simple mechanical tool with no moving parts.

2. This tool is reliable

3. Complete separation of ash from coals above a certain size can be accomplished in a time efficient manner

3. This tool and technique of use allow the restart a fire in two to five minutes as opposed to the ten to twenty minutes required with the conventional cleaning, paper and kindling method.

4. The volume and heat content of the discarded ash material is reduced, making disposal less hazardous.

5. This tool saves and puts to use the heat content of the coals which would otherwise be discarded.

6. This tool supplements the existing standard fireplace tool set. No existing tool is rendered obsolete, and this tool easily hangs on most fireplace tool racks.

7. This tool allows the lower frontal area of the firebox to be easily cleaned. This area is not readily accessible to shovel-type implements.

8. This tool allows small size coals to be efficiently saved

These and in all likelihood further objects and advantages of the present invention will become obvious not only to one who reviews the present specification and drawings but also to those who have an opportunity to experience an embodiment of the coal sieve disclosed herein. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

According to various aspects, exemplary embodiments are disclosed of a sieve that may be used for separating sifting particulate matter from a volume of material. In an exemplary embodiment the sieve generally includes sides and a bottom all with apertures or holes through which material such as ash, but not particles such as coals, can pass through. The apertures can be substantially consistent in size and shape. The apertures can pursue any particular shape or combination thereof including, for example, a rectangular shape. Further, the sieve has a handle long enough to extend out of a firebox so that the sides and bottom can remain within the firebox while being shaken via the handle. In an exemplary embodiment the space encompassed by the sides and bottom is large enough to hold a significant portion, or all, of the material to be sifted, but small enough to fit fully within the confines of a firebox. In an exemplary embodiment the handle of the sieve would be at, or very near the top, or below the level of the top of the sides so that the handle would not inhibit entry of the sides and bottom into a firebox.

### DRAWINGS

The drawings described herein are for illustrative purposes only of selected embodiments and not all possible implementations, and are not intended to limit the scope of the present disclosure.

FIG. 1 is a top perspective view of a sieve pursuant to the invention disclosed herein; and,

FIG. 2 is a bottom perspective view.

### DETAILED DESCRIPTION

Example embodiments will now be described more fully with reference to the accompanying drawings.

Before any particular embodiment of the invention is explained in detail, it must be made clear that the following details of construction and illustrations of inventive concepts are mere examples of the many possible manifestations of the invention. While fireboxes, stoves, and the like are commonly referenced herein as the structures from which matter is to be removed, it is to be understood that the sieve could be employed relative to numerous other structures and in widely varied applications.

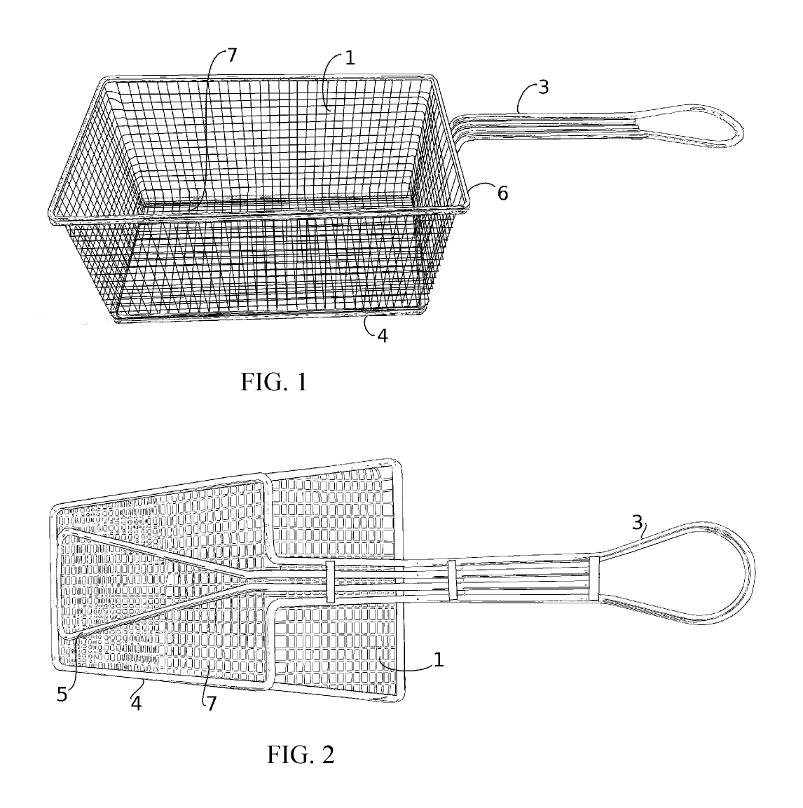

With reference now to the figures, FIG. 1 illustrates an exemplary embodiment of a sieve embodying one or more aspects of the present disclosure. As shown in FIG. 1 the sieve includes a top rigid frame 6 and a bottom rigid frame 4. Between the top rigid frame 6 and the bottom rigid frame 4 the sieve has side walls 1. Between the bottom rigid frame 4 the sieve has a bottom wall 7. Together, the side walls 1 and the bottom wall 7 define a reception volume for receiving a volume of material. In an exemplary embodiment the space encompassed by the sides and bottom is large enough to hold a significant portion, or all, of the material to be sifted, but small enough to fit fully within the confines of the stove or the like being cleaned. The side walls 1 and bottom wall 7 of the sieve contain, or are manufactured in a such a way as to create, a plurality of apertures therein for enabling the passage of material through the sieve. In an exemplary embodiment a plurality of wires are fixed by soldering, welding, or other suitable means to the top rigid frame 6 and the bottom rigid frame 4 to create the side walls 1 and the bottom wall 7 and are spaced such as 1/4″ apart or more to create apertures sized to allow ash and the like to fall through while retaining desired coals.

With continued reference to FIG. 1 the sieve has a handle 3 which is fixed to the sieve by soldering, or welding, or other suitable means. The handle 3 is located at a distance not far, such as 1/2″ or less, above the top rigid frame 6. Alternatively, the handle could also be located below the top rigid frame 6, that is, closer to the bottom rigid frame 4. In any case the placement of the handle should be placed so as to not impede the entry of the sieve into the stove.

With continued reference to FIG. 1 it can be seen that in this exemplary embodiment the dimensions of the top rigid frame 6 are larger than the dimensions of the bottom rigid frame 4. This tapered shape allows the sieve to be nested, one inside the other, for easier and more efficient transport and storage.

FIG. 2 illustrates the underside of an exemplary embodiment of the sieve. FIG. 2 shows the handle of the sieve 3 can be made from wires which extend to also form the bottom rigid frame 4 and a supporting structure 5 for the sides 1 and bottom 7.

A wide choice of materials could be used to construct the sieve. In an exemplary embodiment the sieve is constructed of metal wire. Further, in an exemplary embodiment the said metal wire is coated with a material, such as epoxy powder coating, that will protect the wire from embrittlement and not disfigure at temperatures above 500 F.

Under such an arrangement, a user can, using a common wood stove tool such as a shovel, clear an area in the stove to be cleaned so that area is substantially free from material and then place the sieve, bottom wall 7 down, on that area. Material can then be shoveled, again using a tool such as a shovel, into the sieve. The handle 3 can then be used to gently shake the sieve or move the sieve backwards and forwards, while keeping the side walls 1 and bottom wall 7 within the firebox, or side to side to facilitate the movement of the ash out of the sieve. Once the ash has sifted out of the sieve the handle 3 can be rotated to the side so that the remaining coals exit the sieve and are deposited within the stove. If the amount of material within the stove is greater than the capacity of the sieve than the process can be repeated until all of the material has been sifted. The ash which was sifted out of the sieve can then be shoveled out of the stove, again using a tool such as a shovel, into a waste receptacle. The remaining coals can then be used to help restart a fire.

1. A sieve comprising sides and bottom;
with said sides and bottom having a plurality of apertures;
with an open top;
adapted so that the sieve sides and bottom fit entirely within the confines of an object to be cleaned;
adapted so that the sieve sides and bottom can be rotated 180 degrees within an object to be cleaned;
with a handle fixed to the sieve;
with the handle adapted to support the sieve;
with the handle adapted to extend outside of an object to be cleaned;
with the handle fixed to the sieve for inducing rotational and oscillating movement to the sieve;
and with the handle adapted so that the handle does not extend far, such as 1/2″ or less, above the top of the sieve.

2. (canceled)

3. (canceled)

4. (canceled)

5. (canceled)

6. (canceled)

7. The sieve of claim 1, adapted so that the maximum width of the sieve sides and bottom are one half or less than the width of an object to be cleaned.

8. The sieve of claim 1, adapted so that the maximum width of the sieve sides and bottom are less than the height of an object to be cleaned.

9. The sieve of claim 1, wherein the apertures of the sides and bottom have openings sized to allow ash to flow through while retaining coals in the sieve.
